(19) United States
(12) Patent Application Publication
(10) Pub. No.: US 2006/0179132 A1
(43) Pub. Date: Aug. 10, 2006

(54) Automated replacement of old computer by new computer in network environment

(75) Inventors: Maria Babilon, Dayton, OH (US); Terry Chromey, Dayton, OH (US); Andrea Moretti, Milan (IT); Kevin Sholder, Dayton, OH (US); Bruce Rehnberg, San Diego, CA (US); Chris Brandon, San Diego, CA (US); Charles A. Johnson, Duluth, GA (US)

Correspondence Address: Douglas S. Foote;Intellectual Property Section, NCR Corporation, 1700 South Patterson Blvd., Dayton, OH, 45479-0001, US

(73) Assignee: NCR Corporation

(21) Appl. No.: 11/053,023

(22) Filed: Feb. 8, 2005

(51) Int. Cl. G06F 15/177

(52) U.S. Cl. 709/222; 709/220

(57) ABSTRACT

A system for replacing an existing networked computer with a new computer, as in an organization wherein an employee receives a new computer and must transfer programs and data from an existing computer to the new computer. The new computer, upon arrival, is equipped with an operating system. The invention applies a set of patches to the operating system, to correct known existing issues. The invention (1) installs a set of application programs in the new computer, (2) copies a predetermined set of files from the existing computer to the new computer, (3) establishes default configurations in the new computer, and (4) sets up an electronic mail program in the new computer, which includes correspondence and the address book from the existing computer, and (5) connects the new computer with the network. These processes are undertaken largely without human involvement. Thus, a large fraction of the functionality of the existing computer is replicated on the new computer.

The invention concerns automated replacement of a networked computer, as when an employee of an organization obtains a new computer, which replaces an existing computer.

### BACKGROUND OF THE INVENTION

Most computer users know that replacing, or re-installing, an operating system in a computer is a time-consuming task, primarily because, in many cases, an array of programs and much data must also be replaced as well.

When a member of an organization acquires a new computer intended to replace an existing computer connected to a network, the member encounters a similarly time-consuming task.

The invention herein provides an automated system for connecting a new computer to a network, or replacing an existing computer already connected to the network.

### OBJECTS OF THE INVENTION

An object of the invention is to provide an improved system for replacing networked computers.

### SUMMARY OF THE INVENTION

In one form of the invention, an employee of an organization uses a single computer disc to supply and run certain programs to both a new, and an existing, computer which is connected to a network. These programs replicate selected functionality of the existing computer onto the new computer, without requirement of input data from the employee, with the exceptions that the employee may be required to (1) provide certain identification about himself, and (2) provide certain identification about one, or both computers.

### BRIEF DESCRIPTION OF THE DRAWINGS

FIGS. 1-8 are flow charts, written in pseudo-code format, which describe processes undertaken by various forms of the invention.

FIG. 9 is a flow chart which provides an overview of one form of the invention.

### DETAILED DESCRIPTION OF THE INVENTION

### Overview of Invention

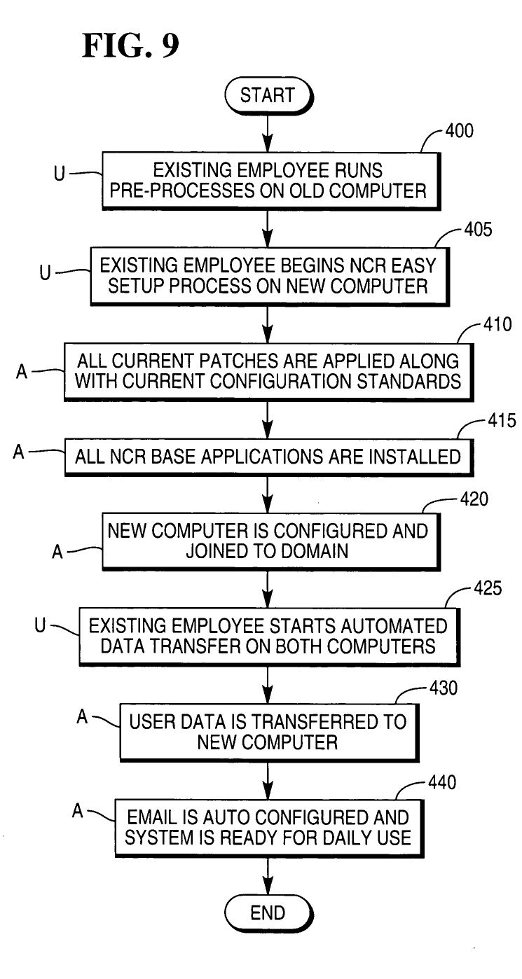

FIG. 9 is a flow chart illustrating processes undertaken by one form of the invention. Some blocks are labeled “U,” indicating that user interaction is required, such as inserting a program disc, providing information about the user, providing information about the computer, or ordering a process to begin. The blocks labeled A indicate automatic processes, which require no user interaction.

Block 400 indicates that an employee, who previously had used an existing computer, runs certain pre-processing operations. These operations perform tasks such as copying selected files needed by the employee to a temporary storage location, which is available to a new computer, later described.

Block 405 indicates that the employee initiates an Easy Set Up program on the new computer. The new computer, in general, will arrive with an operating system installed, such as one of the Windows family available from Microsoft corporation. The term NCR refers to an organization to which the employee belongs, and which maintains a network of computers.

Block 410 indicates that the processes initiated in block 405 install the current patches to the operating system. Also, configuration settings are established in the new computer. The configuration settings include items such as

1) selection of details of appearance of the displays presented by various application programs,

2) grants of access privileges given to the new computer, such as specifying to which domains and files access is granted,

3) restrictions on access to content within the new computer, such as those established in the registries of the Windows operating system, and which restrict access by outsiders,

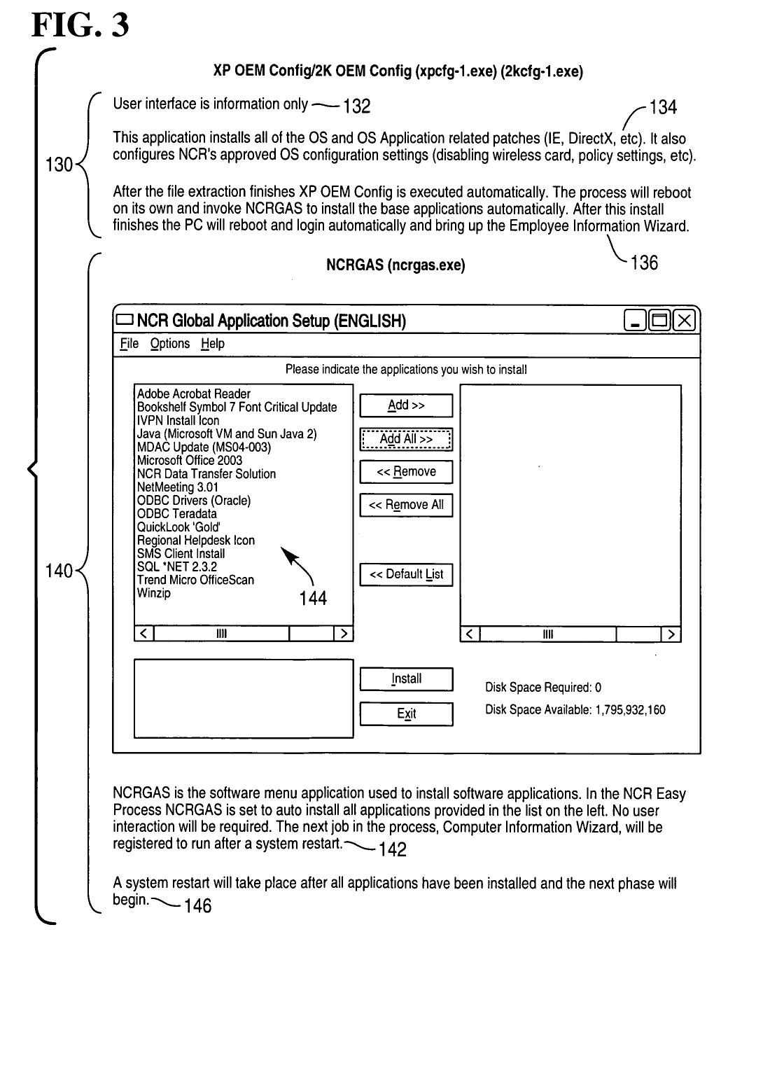

4) configuration of electronic mail programs, to make them operable and conform to certain standards, Block 415 indicates that a base group of application programs is installed in the new computer. Group 144 in FIG. 3 provides an exemplary group of such programs.

Block 420 indicates that steps are undertaken on the new computer to properly configure it to join the network maintained by the organization, and the new computer is joined to the domain. The configuration steps include verification steps to assure that the employee requesting the network connection is authorized, and also steps to establish various defaults, such as a default domain to which the new computer connects upon logon.

Blocks 425 and 430 indicate that the files which were transferred to the temporary storage location are now transferred to the new computer, using the network connection described in block 420. These files, in general, are specific to the individual employee, and are different from similar files which are specific to other employees. For example, a given file may contain an address book of electronic mail addresses. But the address books for different employees will, of course, be different.

Block 440 indicates that the electronic mail system used by the new computer is configured, and made ready for use by the new computer. The old computer can then be removed.

The Inventors point out that an overall result of the processes described in FIG. 9 is to, in effect, replicate specified functionality of the employee's old computer in a new computer. That is, as will be explained more fully below, a specific set of application programs is installed in the new computer. The old computer will probably contain a sub-set of those programs, and possibly the entire set of those programs.

However, it is possible that the employee has installed some personal programs in the old computer. The invention does not install those into the new computer, but rather installs a standardized set of programs, and the same standardized set is installed for every new computer which is installed using the invention.

Also, specified files from the old computer are copied to, or otherwise made available to, the new computer. The files can be specified in various ways, as explained herein. Of course, some files of importance to the employee may not be captured by the rules which specify the files, and the employee would copy those files manually. Again, a standardized set of files is copied from the old computer to the new computer, and the standardized set is copied for every new computer installed using the invention.

In addition, the new computer is connected to the network of the old computer, thus replicating the network access previously available in the old computer. And configuration data, such as personal preferences, would be replicated in the new computer.

Therefore, with respect to (1) a specific set of application programs, (2) a specific set of data and files, (3) a specific grouping of configuration data, and (4) access to the network, the new computer will be indistinguishable from the old computer, except for computer-specific features such as computation speed, version of operating system, local storage capacity, and so on.

In addition, creation of these features within the new computer is done automatically, without input from the employee, with the possible exceptions that the employee (1) must initiate certain processes in the new and old computers, (2) provide certain identification about himself or herself, and (3) provide certain status information to the processes, which tell the processes whether they are running on the new or old computer, because different steps are taken on the two computers. Apart from that minor involvement by the employee, the transfer to the new computer is automatic, and requires no human involvement.

The invention provides the further benefit of reducing, or eliminating, involvement by the employee in certain tiresome tasks, otherwise required, in the installation of a new computer. For example, the employee is not required to configure an electronic mail system, as by identifying servers using arcane terminology, such as terms beginning with the prefix “Pop3 . . . ” As another example, the employee is not required to establish certain configuration options, and the invention re-sets certain default options to those required by the system administrator.

For instance, the electronic mail program Outlook Express, in a menu such as “Tools,” provides a sub-menu entry entitled “Options.” This “Options” sub-menu allows a user to select numerous personal preferences. The invention sets many of these preferences to pre-arranged defaults.

As another instance, the “Control Panel” in the Windows operating system provides an icon which produces a menu of “Internet Options.” which allows a user to select numerous personal preferences. The invention sets many of these preferences to pre-arranged defaults.

### Explanation in Greater Detail

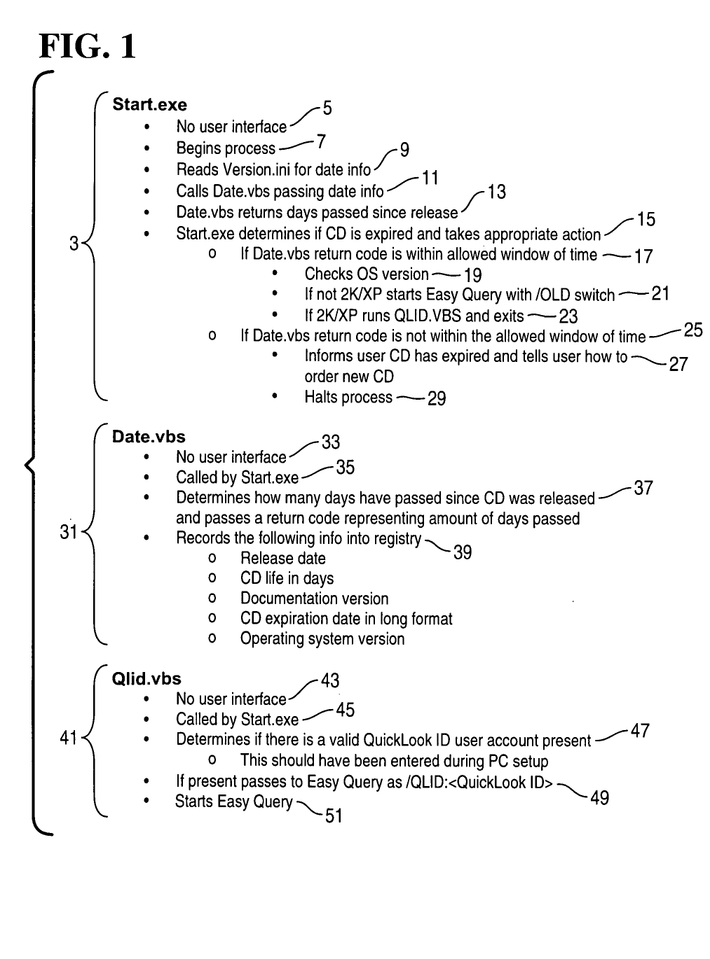

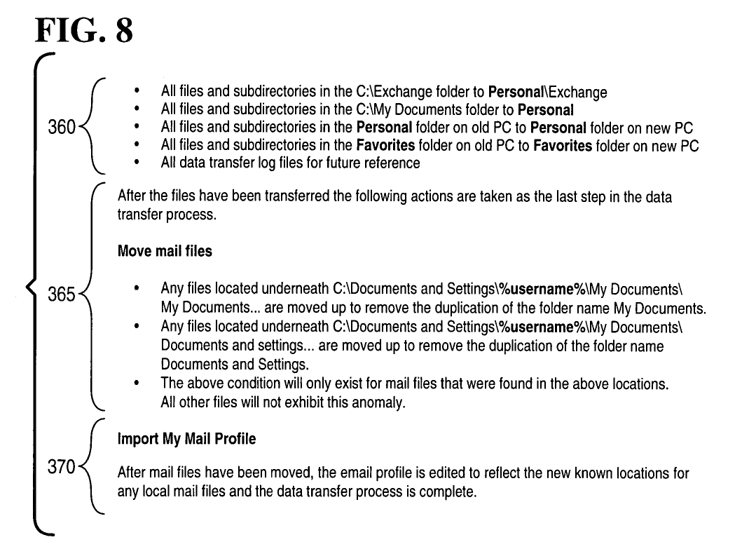

The user first unpacks the new computer, and powers it up. The computer will be equipped with an operating system, supplied by the manufacturer, which will ask for preliminary information, such as a user ID as described by a “Windows Welcome” process, described below. After such preliminary matters, the user inserts a data carrier, such as a compact disc, CD, which contains the software described by the pseudo-code shown in FIGS. 1-8.

### Start.exe and Date.vbs

In FIG. 1, block 3 indicates processes which are implemented by the program “Start.exe,” which runs first. Line 5 indicates that no user interface is involved, although information may be displayed on the computer screen. Line 7 indicates that the process begins. Line 9 indicates that a file “Version.ini” is read from the CD, which indicates the issue-date of the CD, or an equivalent date which can be used for computing expiration. As lines 11 and 13 indicate, “Date.vbs” is called, which is a program on the CD, and is described in block 31.

Line 33 in Block 31 indicates that, again, no user interface is involved, although information may be displayed on the computer screen. Line 35 indicates that “Date.vbs” is called by “Start.exe.” Line 37 computes the time elapsed since the issue date ascertained in block 3, line 13. Also, line 39 indicates that certain data obtained from both the CD and the new computer are written to the registry of the new computer. “Registry” is a storage location used by the Windows operating system for various purposes.

If the elapsed time indicates that the CD is valid, then lines 15-23 take the actions now described. The version of the operating system, OS, within the new computer is checked. If the OS is not a specific operating system, such as “2K/2P,” then line 21 indicates that a routine called “Easy Query,” described below, is started. The term “2K/2P” is shorthand notation for “Windows 2000 Professional or Windows XP Professional,” “Windows” referring to the operating system available from Microsoft Corporation, Redmond, Wash., USA.

If the OS detected is, in fact, Windows 2000 Professional or Windows XP Professional, line 23 indicates that a routine named “Qlid.VBS,” described below, is launched, and “Start.exe” terminates.

On the other hand, if inquiry of lines 15, 17, and 25 indicates that the CD has expired, line 27 indicates that the user is instructed as to how to obtain a valid CD, and line 29 indicates that the process is halted.

### Qlid.vbs

“Qlid.vbs” was called if the proper operating system in the new computer was detected. It is, of course, recognized that the two operating systems represented by “2K/XP” in line 21 in block 3 will, in the future, eventually be replaced by newer, different versions, and perhaps different operating systems entirely. Thus, the issue of whether a proper operating system is present is determined by the needs of the software contained on the CD, and not by the presence of a specific, unchangeable version of a particular operating system.

Line 43 in Block 41 indicates that, again, no user interface is involved, although information may be displayed on the computer screen. Line 47 indicates that the routine looks for a “QuickLook ID,” which is the identification number, or employee number, assigned to the user of the new computer.

In one embodiment, when the user first powers up the computer, the Windows operating system runs a routine called “Windows Welcome,” as mentioned above. That routine asks for a user name, and the user will enter the ID number in question in response. Line 49 indicates that the ID number is passed to the routine “Easy Query,” and line 51 indicates that this routine is started.

### Easy Query

This routine performs two major functions. One, it assures that the user has been supplied with the correct paper instructions which correspond to the CD which has been inserted into the new computer. Two, it assures that the CD is currently installed in the new computer. This is important because the same CD will be later installed into the user's old computer. The CD performs different functions in the two computers, so it is important that the correct functions be selected for each computer.

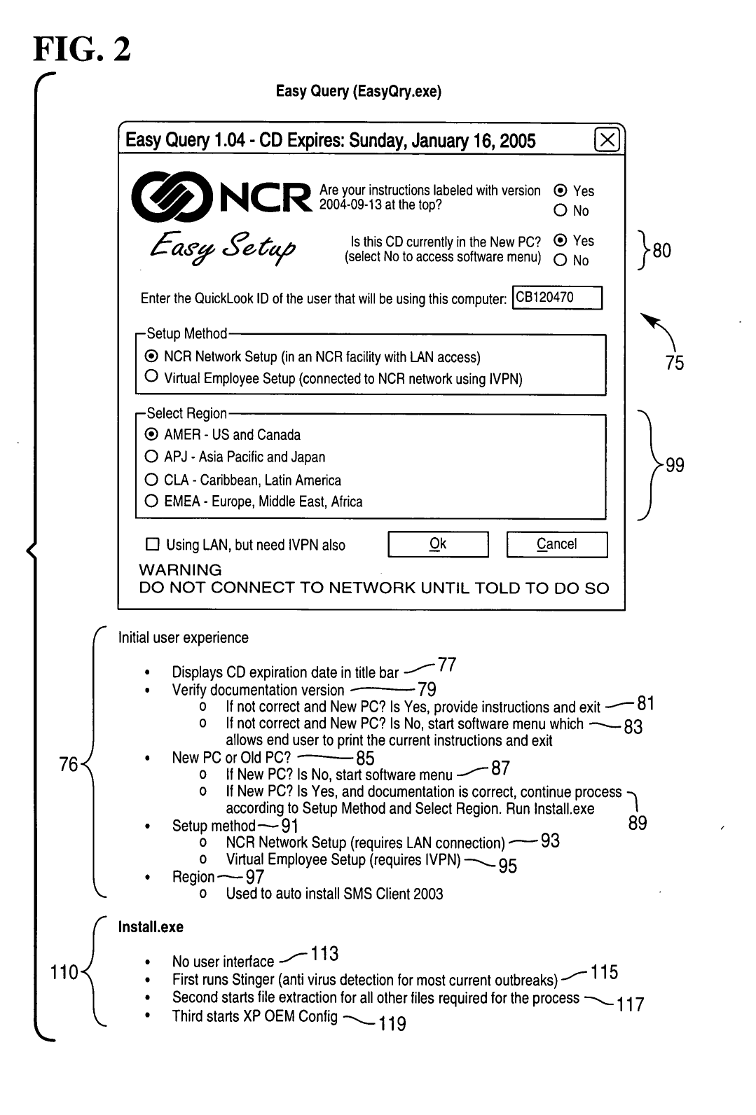

Block 75 in FIG. 2 illustrates an initial screen displayed by the routine “Easy Query.” Line 77 in block 76 indicates that the top of block 75 displays the expiration date of the CD, which is Jan. 16, 2005, in this example.

Lines 79, 81, and 83 ascertain whether the user has been supplied with the correct paper instructions for the CD, and whether the user is operating a new computer, PC. “Verify document version” in line 79 refers to the inquiry “Are your instructions labeled with version 2004-09-13 at the top ?” located near the top of block 75. Bracket 80 indicates that the routine asks the user whether the CD is installed in the new computer, as opposed to the old computer.

If the paper instructions lack the correct version number, and the CD is inserted into the new PC, line 81 indicates that correct instructions, either on-screen or printed on paper, are provided.

If the paper instructions lack the correct version number, and the CD is not inserted into the new PC, line 83 indicates that correct instructions are made available, and the routine exits. This allows the user to insert the CD into the new computer.

Lines 85, 87, and 89 inquire whether the CD has been inserted into the new computer. If not, line 87 starts a software menu which, among other things, tells the user to insert the CD into the correct computer. If the CD has, in fact, been inserted into the new computer, line 89 indicates that processing proceeds, and “Install.exe” is called.

“Easy Query” performs two other functions. One, it determines the type of network to be installed. One possible network is a Local Area Network, LAN, wherein all computers are located within specified geographic areas. This LAN is also called an intra-net.

For example, all the computers may be required to connect physical cables to the network grid, and thus be within cable-length-limits. As another example, these cables may allow wireless connections. But even in this other example, all computers still must stand within specified geographic areas.

The other possible network is an Internet Virtual Private Network, IPVN. In this network, users use the Internet, or other external network, to connect to the LAN of the previous paragraph from remote locations.

“Easy Query” allows the user to select between the two networks, in block 75, as indicated by lines 91, 93, and 95.

The second other function allows the user to select a geographic region, as indicated by bracket 99. Different components are installed, depending on the region selected, as indicated by line 97.

### Install.exe

Line 113 indicates that no user interface is involved, although information may be displayed on the computer screen. Line 115 indicates that an anti-virus program is run. Line 117 indicates that files are extracted. Extraction can be required if the files are compressed. Line 119 indicates that the program “XP OEM Config” is started.

XP OEM Config.

As line 132 in block 130 indicates, the user interface, or screen displayed to the user, is informational only. No user input is required.

Lines 132 indicates that this application installs the operating system, and other items related to the operating system. In general, lines 132 indicate that an operating system is installed, thereby allowing ordinary application programs to be installed and run on the new computer.

Lines 134 also indicate that certain configuration settings are established. For example, any wireless card may be disabled. This can be necessary if such cards are not supported by the system administrator of the LAN to which the new computer will be connected. Also, the presence of a wireless card could, under some circumstances, interfere with the data transfers into the new computer, described later.

Lines 134 further indicate that certain policy settings are established. These settings can include, for example,
a minimum password length,
disabling and re-naming of the Guest account,
requiring the user to set and use a logon name,
disallowing clear text passwords (which are displayed as they are typed, as opposed to being obscured as typed),
disabling services not required for daily use, for security reasons,
disabling automatic updating to the operating system, and possibly also to selected applications,
setting initial wallpaper to a common wallpaper used by all computers in the LAN, and
enabling a specific screensaver and requiring a password,

As lines 136 indicate, the program causes the new computer to re-boot, and another program, “ncggas.exe” is run.

### ncrgas.exe

As lines 142 in block 140 in FIG. 3 indicate, a collection 144 of programs is installed automatically, without user interaction. As lines 146 indicate, a re-boot occurs automatically, and the program pcconfig.exe is run.

### pcconfig.exe

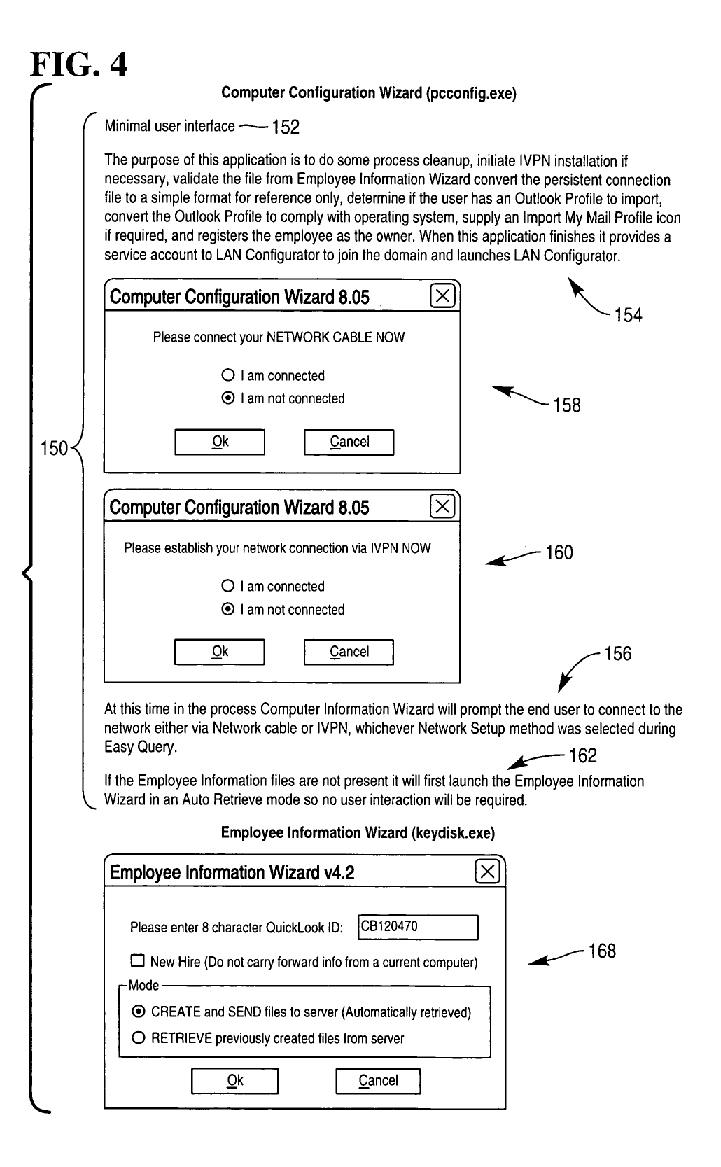

As line 152 in block 150 in FIG. 4 indicates, a minimal user interface is used, wherein only small amounts of user input is required.

Lines 154 indicate that process cleanup is required. Some examples of process cleanup include (1) removing known temporary directories, (2) deleting files such as C:\NCRAPPS\IE6SP1 and C:\NCRAPPS\PSETUP.

Lines 154 also indicate that validating a file received from Employee Information Wizard may be performed. Validating means that the file is examined, to assure that the file contains the required content. This examination can be important because it is possible that an older version of the file may be present, and the validation step assures that the older, incorrect version is not used.

Lines 154 indicate that persistent connections are suppressed, and the file indicating the server(s) to which the persistent connection(s) are made is converted to a reference file, and is thus rendered inactive.

Lines 154 indicate that an Import My Mail Profile icon is supplied. This icon actuates a script which converts the e-mail profile for use in Microsoft Outlook, and thereby eliminate the requirement of the user to create the profile. For example, the profile involves creation of arcane codes involved in the e-mail handling process, and the icon in question automates the code creation.

Lines 154 indicate that a service account to a LAN configurator is provided. In order for the user's new computer to join the LAN, a domain user LAN account must be present. This account is set up, including an account name and password.

Lines 156 indicate that the user is prompted to make the connection to the LAN, in the manner selected by the user. Blocks 158 and 160 are displayed to the user, and the user enters the proper input.

This connection was not made earlier, for example, at the time the user unpacked the new computer and powered it up for the first time. One reason is that, at that time, security precautions had not been implemented. However, at the time the processes of lines 156 in FIG. 4 are undertaken, such security precautions have been implemented, thereby preventing the entry of viruses and worms into the new computer.

Lines 162 indicate that a search is made of one, or more, servers in the newly available LAN, in pursuit of specific files relating to the user of the new computer. If those files are not found, the Employee Information Wizard, “keydisk.exe,” is launched.

### keydisk.exe

If the Employee Information Wizard, EIW, is launched, block 168 in FIG. 4 is displayed to the user. If the employee's ID number is not found in storage, block 168 requests that the user enter it.

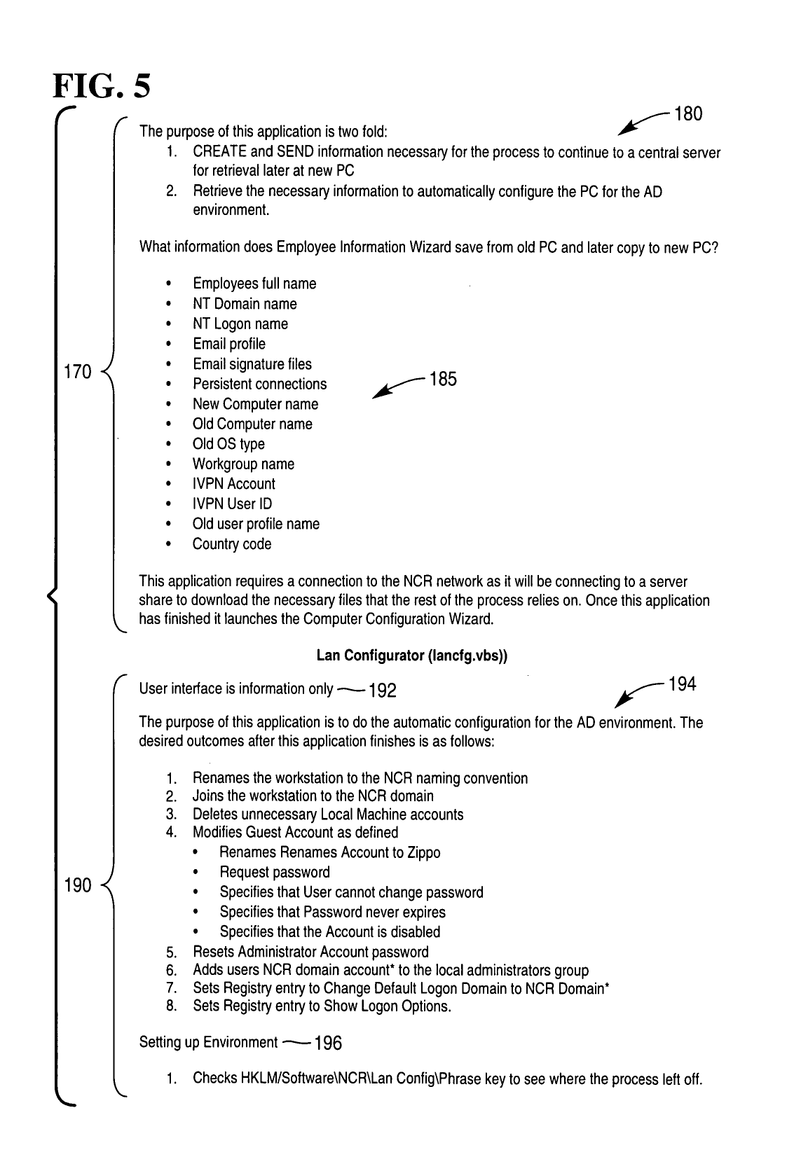

The EIW performs different tasks, depending on whether it is running on the old computer or the new computer, as indicated by lines 180 in block 170 in FIG. 5. At the old computer, the EIW stores the data 185 into a file, or share, in a central server, which is connected to the LAN. At the new computer, the EIW retrieves data 185 from the central server.

The EIW can be run in advance, at the old computer, to store data 185 in the central server. If that is done, then the processes indicated by lines 162 in FIG. 4 would automatically retrieve the data 185. If the EIW is not run in advance, but during, or near, the processes described at the bottom of FIG. 4, then the EIW is run on the old computer, and the option “CREATE and SEND . . . ” in block 168 would be selected. The EIW then stores the data 185 in FIG. 5 into a file, or share, in a central server. The process indicated by the last phrase in lines 180 in FIG. 5 is then executed, retrieving data 185 into the new computer.

In lines 180, “AD” means “Active Directory.”

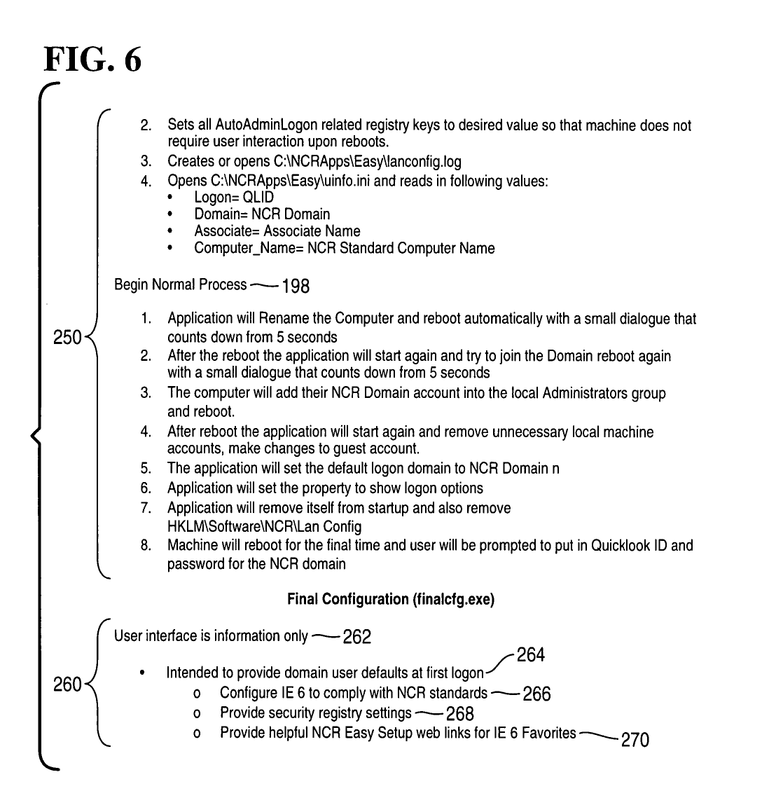

Therefore, one overall purpose of the EIW is to retrieve certain data from the old computer. This data is of the type required to set up an account for the new computer, and allow the new computer to connect to the LAN, either directly, through the IVPN, or both. Then the Computer Configuration Wizard, LAN Configurator, is launched. Block 190 in FIG. 5 and block 250 in FIG. 6 describe the operations undertaken.

Line 192 indicates that the interface displayed is informational only. Little, or no, user input is required.

Lines 194 indicate the primary purposes of the LAN Configurator. The entries following line 198 in FIG. 6 provide greater detail explaining how the purposes are accomplished. Entry 1 following line 194 in FIG. 5 indicates that the new computer is re-named according to conform to conventions of the organization operating the LAN. Entry 2 indicates that the new computer is granted access to resources in the domain, and is managed by the domain administrators.

Entry 3 indicates that certain local machine accounts are deleted. Such accounts allow access only to the local machine.

Entry 4, and the sub-entries, take actions which, in effect, disables the guest account. This process creates difficulty for hackers to enter the system through the guest account.

Entries 5 and 6 allow the user to install software into the new computer, since only administrators are allowed to perform such installations.

Entries 6 and 7 are done so that the user need not later perform the indicated actions.

Lines 196, and the following entries, indicate steps taken in setting up the new computer. Entry 1 indicates that a check is made to see where the system should start during re-boots.

Entry 2 allows the new computer to automatically log into the LAN upon a reboot. Otherwise, user interaction would be required.

Entry 3 creates, or opens, a specific file which is used for audit purposes.

Entry 4 reads in specific data to a specific file. The data is needed in this file so that the new computer can log into the LAN, and the processes of entry 4 eliminate the need for the user to manually enter the data.

As stated above, the entries following line 198 in FIG. 6 indicate several steps which are taken to achieve the goals listed following lines 194 in block 190 of FIG. 5.

Entry 1 indicates that the computer is renamed, and rebooted, consistent with entry 1 in block 190 of FIG. 5.

Entries 2 and 3 following line 198 in FIG. 6 indicate that the new computer will be joined to the Domain as a valid Domain client.

Entry 4 following line 198 in FIG. 6 indicates that unnecessary accounts are removed, consistent with goal 3 of block 190 in FIG. 5.

Entry 5 following line 198 in FIG. 6 indicates that a default domain is selected upon logon by the new computer.

Entry 6 indicates that certain options are displayed upon logon by the new computer. For example, a drop-down list of available domain names is made available. As another example, an option is provided which allows logging on using a dial-up connection.

Entry 7 indicates that the application removes itself, and allows the process to restart from the beginning.

Entry 8 indicates that a final re-boot occurs, upon which the user enters his user ID and password, which is already known to him.

Final configuration is then undertaken.

### Final Configuration (finalcfg.exe)

Line 262 in block 260 in FIG. 6 indicates that the user interface provides information only. No user interaction is required.

Line 262 indicates that default conditions are established upon the first logon by the user. These defaults include configuring Internet Explorer version 6 (IE 6) to comply with standards set by the organization operating the network. Also included are changes to the security registry, as indicated by line 268. Line 270 indicates that links are established for preferred web sites.

Then an automated data transfer is undertaken.

### Automated Data Transfer Solution (NCRData.exe)

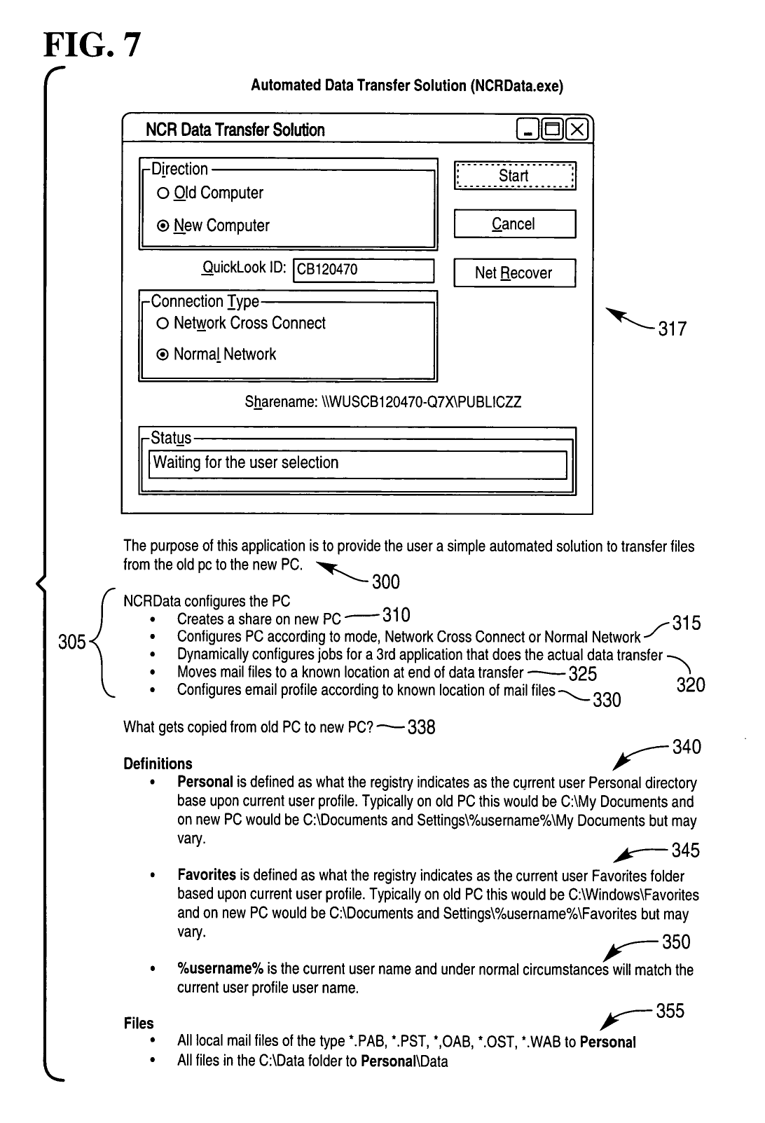

As line 300 in FIG. 7 indicates, files are transferred from the old computer to the new computer. It should be recognized that transfer to the new computer itself is not necessarily required, but that making the files available to the new computer can be an important goal. To that end, some or all files may be transferred to a third location to which the new computer has access.

Block 305 lists overall goals to be completed in the file transfer. Line 310 indicates that a share is created on the new computer, meaning that a file sharing program is set up which allows copying of files from one computer to another.

Line 315 indicates that a configuration is made, as indicated by the selection made by the user in menu 317, which sets the correct type of connection between the two computers.

Line 320 indicates that configuration details are established for a program which transfers the files.

Line 325 indicates that electronic mail files are transferred to a known location.

Line 330 indicates that the user's electronic mail profile is configured.

Blocks 340 and 345 list two categories of data. Block 340 specifies one category as “Personal,” and indicates that files from a specific location in the old computer are copied, or transferred, to a specific location in the new computer.

Block 345 specifies another category as “Favorites,” and indicates that files from a specific location in the old computer are copied, or transferred, to a specific location in the new computer. This category can include a collection of URLs, or web site addresses, frequently visited by the user.

Block 350 indicates a label given to the user's name.

Blocks 355, 360, and 365 list files in the old computer which are copied or transferred to the new computer, and indicate locations of origin and destination of the files. In the general case, the files in the old computer can be specified by (1) name, (2) suffix or extension, (3) presence of a character string in the file name (for example, the files “stanford.exe” and “fordmotor.com” both contain the string “ford”), (4) content, (5) location, (6) date of creation, (7) program creating the file, (8) content of a header in the file, or (9) any other approach which can select desired files from a group of files.

### Significant Features

1. The invention allows a person within an organization which maintains a network of computers to connect a new computer to the network without human intervention, with the exception of (1) providing program discs to the computer, (2) providing the person's identity, (3) providing certain information about the new computer, (4) ordering certain processes to begin, and (5) connecting the new computer to a network cable at the correct time.

In one form of the invention, the network is a private network, as opposed to a publicly available network, such as the Internet.

2. The invention allows a person who uses a network computer to perform tasks to replace that computer with a new computer which will also perform the same tasks, automatically and without personal involvement.

3. The invention allows a person who (1) works within an organization which maintains a network of computers, and (2) operates one of those computers, to replace that computer with a new computer, and also to replicate a significant subset of the functionality of the old computer in the new computer, automatically, without personal involvement, with the exception of selecting certain options and providing identity information.

4. The invention allows a person to connect a computer to a network, without configuring a network card or submitting data about the network.

5. The discussion above indicated that no user involvement, or minimal user involvement, is required to install the new computer. In some cases, the user may be required to perform some ministerial tasks, but those tasks require no technical expertise, and amount to nothing more than following simple instructions which the invention presents to the user. Such instructions are sufficiently simple that the average high school graduate can follow them.

6. It is significant that the invention eliminates requirements imposed by other approaches which can be used. In one approach, a fully functional computer is created for use by the user, and an image of the fixed drive of that computer is generated. The image is a direct copy, sector-by-sector, of the entire physical fixed drive. That image is then loaded onto other computers, one for each user, thereby, in effect, copying the fully functional computer for each user. This loading operation can be performed by the manufacturer of the computer. However, the manufacturer generally imposes a fee for this loading operation.

In addition, one problem with this approach is that, in general, because of subtle differences between computers manufactured by different manufacturers, and even between different models of computer manufactured by a single manufacturer, a unique image is required for each make and model of computer. Thus, to accommodate twelve different types of computer, twelve different images are required.

Further, the viability, or compatibility, of each image with its make-and-model of computer must be tested, which can require days or weeks of technician time.

Further still, software evolves rapidly. A small delay time will necessarily exist between the establishment of a suitable image for a computer, and the delivery of a new computer, equipped with that image. In that delay time, upgrades to some of the software contained in the image may have occurred. And new viruses may have arisen during that delay time, requiring new suppression software.

Therefore, even under the image-approach, some involvement by a technician is required, at least for testing and updating the image.

In contrast, under the invention, a new computer arrives with pre-installed software provided by a manufacturer, or a factory load. The invention installs a core set of application programs, and establishes (1) security settings, (2) patches, (3) user profiles, (4) electronic mail settings, (5) and data transfer to the new computer.

Further, the invention accomplishes these tasks using a single compact disc, CD, and eliminates all need for a trained technician.

7. The invention eliminates the requirement of multiple images, and, in one embodiment, reduces the inventory of software required to install a new computer to the contents of a single CD.

Also, under the image-approach, if one computer maker changes its computer, or if one supplier of an operating system makes a change, the relevant images must be tested on the relevant hardware, and then possibly changed. Under the invention, a single change to a single CD will accommodate the modifications by the manufacturers.

8. The invention allows a non-technical person to convert a generic personal computer, fresh from the manufacturer, into a corporate-ready computer which contains all personal data required by the individual end user to perform the customary daily tasks of the end user. This conversion is accomplished using the CD described above, by following instructions generated by the CD, and in possible conjunction with a small instruction manual which, in one embodiment, contains eight or so pages.

9. The conversion process just described can be completed at a corporate site, using two network ports, one for the old computer and one for the new, or elsewhere, using a single data transfer cable.

10. A significant feature, not found in the prior art, is that the conversion process described above can be accomplished by an untrained individual, without the involvement of any computer technicians whatsoever.

11. The conversion can be accomplished irrespective of the make or model of the new computer, provided, however, that the new computer conforms to a standard architecture, such as the Personal Computer Architecture developed by IBM Corporation, or the MacIntosh computer developed by Apple Computer Corporation, for example.

Stated another way, any differences between different makes and models of computers are handled largely by the manufacturer, as by installing an operating system which is compatible with the computer. That operating system is identified by the invention, and modified as appropriate.

Consequently, the corporate user of the invention can change the computer make and model used at any time, and the invention will still allow conversion to new computers of that new make and model.

12. The discussion above stated that certain files and documents are copied from the user's old computer to the new computer. In the general case, the user will utilize a favored set of programs, which store the files in a manner which can be systematically identified. For example, a given word processor will store documents with a known suffix, such as “.doc”.

As another example, a given electronic mail program will store mail messages, both sent and received, in specific locations.

Under the invention, the systematic storage nature used by these programs is recruited to locate the user's personal files, and to transfer the personal files to the new computer.

Of course, the user can take steps, either intentionally or unintentionally, to defeat this transfer. For example, if the user altered the suffixes of the word processing documents, then the invention may not locate them, and they may not be transferred automatically.

13. The invention allows multiple users to install new computers simultaneously, limited only by the numbers of physical network connections available. Significantly, there is no limit imposed by the number of technicians available, because the technicians are not involved.

14. In one form of the invention, existing functionality in the old computer is not merely replicated in the new computer, but is also enhanced. For example, an existing word-processing program in the old computer can be replaced by a newer version in the new computer. As another example, virus-scanning software in the old computer can be replaced by a newer version in the new computer.

Numerous substitutions and modifications can be undertaken without departing from the true spirit and scope of the invention. What is desired to be secured by Letters Patent is the invention as defined in the following claims.

1. For an organization in which multiple computers are connected to a private network, an article of manufacture, comprising:
a) a computer-readable storage medium;
b) software means, physically configured in the storage medium, for connecting a new computer to the network, without human intervention apart from log-in and verification procedures.

2. Article according to claim 1, wherein
1) the new computer replaces an existing computer of a user, and
2) the software means provides to the user access to received electronic mail messages previously available through the existing computer.

3. Article according to claim 1, wherein
1) the new computer replaces an existing computer of a user, and
2) the software means provides to the user access to sent electronic mail messages previously available through the existing computer.

4. Article according to claim 1, wherein
1) the new computer replaces an existing computer of a user, and
2) the software means provides to the user access to an electronic mail address book previously available through the existing computer.

5. Article according to claim 1, wherein
1) the new computer replaces an existing computer of a user, and
2) the software means provides to the user access to documents of a predetermined type, previously available through the existing computer.

6. Article according to claim 1, wherein
1) the new computer replaces an existing computer of a user, and
2) the software means provides to the user access to documents having names containing a predetermined character string, previously available through the existing computer.

7. Article according to claim 1, wherein
1) the new computer replaces an existing computer of a user, and
2) the software means provides to the user access to documents in one or more predefined locations, previously available through the existing computer.

8. For an organization in which multiple computers are connected to a private network, and each computer is used by a respective user to perform a set of tasks, wherein some tasks involve the network and other tasks do not, an article of manufacture, comprising:
a) a computer-readable storage medium;
b) software means, physically configured in the storage medium, for
i) connecting a new computer to the network and
ii) enabling a user of an existing computer to perform the user's set of tasks using the new computer.

9. Article according to claim 8, wherein the software means performs the enabling means without human intervention apart from log-in and verification procedures.

10. For an organization in which multiple existing computers are connected to a network, and all existing computers contain the following core program set:
1) a common operating system,
2) an application program A,
3) a common set of configuration parameters for program A,
4) an application program B, and
5) a common set of configuration parameters for program B, an article of manufacture, comprising:
a) a computer-readable storage medium; and
b) software means, physically configured in the storage medium, for establishing the core program set in a new computer, without human intervention apart from possible log-in and verification procedures.

11. Article of manufacture according to claim 10, wherein
1) each existing computer stores a data set and a file set for a respective user, and
2) the software means makes the data set and the file set available on the new computer.

12. Article of manufacture according to claim 10, wherein
1) a new computer replaces an existing computer of a user, and
2) the software means makes available in the new computer the electronic mail messages, both sent and received, available to the existing computer.

13. Article of manufacture according to claim 10, wherein
1) a new computer replaces an existing computer of a user, and
2) the software means makes available in the new computer the electronic mail address book available to the existing computer.

14. Article of manufacture according to claim 10, wherein
1) a new computer replaces an existing computer of a user, and
2) the software means makes available in the new computer files of a predetermined type which are available to the existing computer.

15. Article of manufacture according to claim 10, wherein
1) a new computer replaces an existing computer of a user, and
2) the software means obtains data required to connect the new computer to the network.

16. An article of manufacture, for use with an existing computer connected to a network, comprising:
a) a computer-readable storage medium;
b) software means, physically configured in the storage medium, for
i) obtaining, from the existing computer, data needed to set up a network account for a second computer; and
ii) setting up a network account for the second computer, using the data.

17. Article according to claim 16, wherein the process of setting up the network account proceeds without human intervention after receiving initial status data from a user.

18. Article according to claim 16, wherein the data obtained from the existing computer is stored at a remote location, and is retrieved from the remote location in setting up the network account.

19. Article according to claim 18, wherein the remote location is within a computer connected to the network.

20. Article according to claim 18, wherein the network account is set up after the second computer is connected to the network.

21. An article of manufacture, for use in replacing an existing computer connected to a network with a replacement computer, comprising:
a) a computer-readable storage medium;
b) software means, physically configured in the storage medium, for copying
i) contents of at least one predetermined directory from the existing computer to a comparable directory in the replacement computer; and
ii) predetermined data from the existing computer to the replacement computer.

22. An article of manufacture, comprising:
a) a computer-readable storage medium;
b) software means, physically configured in the storage medium, for:
i) causing a first computer to transfer predetermined data from the first computer to a storage location remote from the first computer; and
ii) causing a second computer to
A) retrieve the predetermined data from the storage location, and
B) use the predetermined data to set up a network connection for the second computer.

23. An article of manufacture, comprising:
a) a computer-readable storage medium;
b) software means, physically configured in the storage medium, for:
i) transferring predetermined data from a first computer, which is connected to a network, to a storage location remote from the first computer;
ii) setting up an operating system in a second computer;
iii) setting up a predetermined collection of programs in the second computer, which utilize the operating system; and
iv) retrieving the predetermined data from the storage location, and using the predetermined data to set up a network connection for the second computer.

24. For an organization in which multiple computers are connected to a private network, wherein one of said computers is used by a person to accomplish a collection of tasks, a method, comprising:
a) running one or more programs which
i) enable the person to connect to the network using a new computer; and
ii) enable the new computer to perform the collection of tasks.

25. Method according to claim 24, and further comprising:
b) making previously existing electronic mail files available to the new computer.

26. A method for use with an existing computer connected to a network, comprising:
a) running first processes on the existing computer;
b) running second processes on a new computer; wherein the first and second processes
i) replicate, in the new computer, functionality of a set of programs contained in the existing computer,
ii) replicate, in the new computer, a set of files contained in the existing computer,
iii) establish configuration defaults in the new computer, and
iv) connect the new computer to the network, without intervention of a human, apart from possibly obtaining the following from a human: (1) identity information about the human, (2) identity information about the existing and new computers.
